(19) United States
(12) Patent Application Publication
(10) Pub. No.: US 2015/0286869 A1
(43) Pub. Date: Oct. 8, 2015

(54) Multi Mode Augmented Reality Search Systems

(71) Applicants: Peter Ellenby, San Francisco, CA (US); Thomas W. Ellenby, San Francisco, CA (US); John Ellenby, San Francisco, CA (US)

(72) Inventors: Peter Ellenby, San Francisco, CA (US); Thomas W. Ellenby, San Francisco, CA (US); John Ellenby, San Francisco, CA (US)

(21) Appl. No.: 14/245,287

(22) Filed: Apr. 4, 2014

(51) Int. Cl. G06K 9/00; G06F 3/01; G06F 17/30; G06T 15/20; H04N 5/232; G06K 9/78; G06F 3/0481

(52) U.S. Cl. CPC G06K 9/00671; G06K 9/78; G06F 3/011; G06F 3/04815; G06T 15/20; H04N 5/23216; G06F 17/30247; G06K 2209/27

(57) ABSTRACT

Augmented reality systems recall prescribed stored information relating to scenes being addressed by an optical imager based upon a multiplicity of alternative search modes each based upon different criteria related to both systems states and environmental states. Primarily, sensor based and visual based search modes are switched depending upon physical states of these augmented reality type platforms. When deployed in near-field uses, information recall is primarily based upon image recognition algorithms and strategy. Conversely, when these augmented reality imaging systems are deployed in far-field type uses, search modes switch to those modes based upon sensors which measure physical attributes and states of the device, and subsystems to determine probable matter being addressed.

### CONTINUING INFORMATION

This application is a continuation-in-part type application which continues from U.S. patent application Ser. No. 13/414,870 filed on Mar. 8, 2012 and pending this even date, that application in turn claims benefit from provisional application filed Mar. 14, 2011 having application No. 61/465,096.

### BACKGROUND OF THE INVENTION

1. Field

The following invention disclosure is generally concerned with augmented reality type imaging and visual systems and more specifically concerned with stored data recall modes which depend upon system, scene and environmental states as measured by these imaging platforms.

2. Background

Augmented reality (AR) is a term which can be used to describe a live view image of a physical or ‘real-world’ environment, wherein elements of the image are augmented by computer-generated matter such as graphics, text, icon, multi-media and other information.

For graphics and information generated by a computer to be most relevant, AR systems need to ‘know’ what is within their field-of-view or what subjects or subject types are being addressed by the imaging platforms. Systems that are used to generate the augmented graphics may be prescribed to fall within two category classes characterized as: 1) visual based AR, and 2) sensor based AR.

Visual based AR systems analyze image content to find basis from which a search may produce useful computer generated components. Based upon image processing algorithms, image scenes are analyzed to yield features from which a database search may be based. Search results may then be fashioned as computer generated objects and those graphics may be displayed in relation to a detected pattern or object in the captured image. The system may ‘look’ for markers in a captured image of a scene that may be machine analyzed in a computing processor of the mobile device or conversely, images may conveyed and transmitted to remote computing stations to be analyzed there, for example via cloud computing resources. Results are returned and used to to form computer generated imagery which may be displayed along with and overlaid upon actual images of scenes being addressed. These methods generally work best where imaged objects lie near or in ‘near-field’ applications, and additionally in well-lit situations with no intervening obstructions. Examples of visual based AR systems include those sometimes known as “Google Glasses” iPhone application from Google Inc., and the “Panasonic 3D Viera AR Greeting” application for iPhone from Panasonic Corporation.

Conversely, sensor based AR search systems rely on using sensors such as, GPS, compass, accelerometers and gyroscopes to determine physical spatial states of the device, the imaging environment, objects in the image, for example position, location and attitude or ‘pointing direction’ of the imager. Such a device can then query a database of information objects that have a fixed and known location associations and determine what is being addressed with respect to the device location and pointing direction. This method is best for mobile applications where the user is out and about in the world and is gathering information about objects that are sometimes at a great distance or obscured by buildings in the imager line of sight, inclement weather, hills, vehicles or other physical obstructions and objects not of primary interest. Examples of sensor based AR systems and methods are well described in U.S. Pat. No. 5,815,411 “Electro-optic vision systems”, U.S. Pat. No. 7,031,875 “Pointing systems for addressing objects” and the “World Surfer” applications for iPhone and Android from GeoVector Corporation.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, Peter Malcolm, Thomas W. and John Ellenby with inventions of multi mode search apparatus and methods for augmented reality visual systems.

The present invention includes methods of switching between visual based and sensor based search methods—in response to multiple detected conditions. It can be imagined that one may want to have a single device or application that is capable of performing both visual based and sensor based AR depending on the situation they find themselves in. Imagine a user who is in an art gallery. They see a painting they would like to know more about. They address it with their AR device and it analyzes the image, determines what the painting is and recalls from a prescribed computer memory information relating to the addressed object and further delivers a wealth of information about the painting as a presentation consumed by the user via viewing. With the same AR device, a user may then step out of the art gallery onto the street to see a nondescript building in the distance and decides they would like more information about it. They address the building with their AR device by pointing it theretowards the building and the sensors determine the location and the orientation of the device, then query a database based on those spatial parameters to determine which buildings are in that direction. In one version, the device returns a list of buildings from near to far and gives the user a choice of selecting to receive all of the relevant information about the building of interest. The user did not have to tell the device to utilize visual or sensor based AR mode. The device itself determined which mode to use based on the state of the camera. In this example the device analyzed the focal distance of the camera. While in the museum the camera was focused at a short distance and device selected visual based AR mode based on that information. While outside the camera was focused at a great distance and the device was instructed to utilize sensor based AR mode based on the focus state of the system. Other methods of analyzing camera states and image quality can be utilized to determine the recall and search modes, visual or sensor, that the device utilizes. Analyzing the state of the sensors, in particular the GPS or other positioning means, may also be used to determine a preferred mode to be used.

Today we have AR systems that only use position and attitude means to determine what is being addressed by a device. We also have AR systems that rely on visual recognition techniques, the cameras input and analysis of the image, to determine what is being addressed by a device. Typically the position and attitude determining devices are used when a user is querying a real world scene and desires information about a real world object or landmark (sensor mode). The visual devices are usually used when a user is trying to find out more information about a book, CD, painting etc, or is reading some kind of visual encoding such as a barcode or QR code (visual mode) or in some cases recognizing an important building or distinctive landmark. Applications that rely on position and attitude of a device are not very good at identifying small individual objects, and applications that rely on visual recognition techniques are not very good at identifying all buildings, landmarks etc.

The benefits of combining both methods into one device or application would be of great merit to the user who desires both functionalities. Automatically switching between these modes based upon various conditional including those which relate to the system physical and operational states and determining which of the sensors to employ is the subject of the present invention.

One example solution is to monitor the focal length of the camera or system imager as a user addresses an object or scene of interest. If the camera is focusing on an nearby object, or object at a close range it is most likely addressing a small object and visual mode is preferred. It is not necessary to activate a GPS and heading sensors for measurements of physical states of the system to initiate queries based primarily on image content of the scene being addressed—i.e. a visual based search. If the imager is focusing at a distant object (far field) the device is most likely addressing a real world scene and sensor mode based search should initially be executed to recall information relating to the scene. There is less need to analyze the image for recognition of its image and optical content for scenes where the objects of interest are at greater distances from the imager.

Additionally, when such a device is first activated, a camera focal length may be queried and this information may be used to determine which search mode to activate initially. In example, if the imager focal length is determined to be below a certain prescribed threshold value then the device would activate a visual mode, begin analyzing the image and would not query the GPS or attitude sensor at that time. If the focal length is determined to be greater than a certain prescribed threshold value, the device would then activate a sensor mode based search, query applicable sensors including GPS, compass, among others, and search a database based upon the values of these queries. In this way power may be saved and latency reduced by automatically using a search mode appropriate for the scene being addressed—either a near field scene or a far field scene.

Switching between visual based search mode and sensor based search mode may be activated based upon various factors and conditions including by way of example:

1. Distance to an Object of Interest

This distance may be determined by focal length of the imaging means (the camera), an active range finder such as a laser, acoustic or other means. Note that a distance threshold value that determines which type of search to use could itself be modified based upon various factors such as time of day, local light level, high contrast in image, local weather, et cetera.

2. Time of Day

Say for example it is night time in the location where the search is to take place. In this case the default may always be sensor mode as visual mode is seriously degraded at night.

3. Low Light Detected

In this case also the default may always be sensor mode as visual mode is seriously degraded when insufficient light is available to enable an image of sufficient detail to be captured and analyzed. It should be noted that the light level may not be restricted to visual light. Many devices available today have image intensification means or broad spectrum sensitivity and are able to “see” in low light and the infrared and ultra violet spectrums for example. In these cases, even though the local visual light level may appear low to the user of the device, devices with these image intensification or broad spectrum capabilities would potentially still be able to function in visual mode. Additionally illumination by the device itself may be provided in the form of visual light, infrared light, UV etc.

4. Camera Unable to Focus

Focus failure and hence distance determinations using focal length are unavailable. A subset of this may be the instance that the camera is unable to focus due to excessive motion of camera or relative motion of the subject. For example, excessive vibration may be detected by the accelerometers and/or gyros of the device or alternatively by analysis of the captured image stream.

5. Captured Image Contrast

Contrast too high and hence sufficient detail to analyze image is unavailable.

6. Local Weather

With the knowledge of location provided using the position of the device to query a remote service providing local weather information the device may have knowledge of the local weather conditions. Examples when visual mode would be seriously degraded would be heavy rain, fog or snow.

7. Loss of Location

Loss of GPS or other location determining means. In this case sensor mode would be unavailable and visual mode would be the default. This may happen when the device is taken into a building for example. It should be noted that various methods for determining the position of a device when indoors, such as inertial navigation (INS) based upon monitoring the devices accelerometers, gyros, etc. are or soon will be available in miniaturized form and if such positioning was available to the device then sensor mode would still be an option with the device simply switching from one position determining means to another.

8. Severe Magnetic Interference

Magnetic interference likely causing poor compass indications. An example would be complete saturation of the magnetic sensor or over a preset limit such as 90 degree swing reading with negligible motion detected by accelerometer and/or gyro. In this case sensor mode may be automatically disabled. Alternatively, if the magnetic interference is above a first threshold but below a second threshold and the magnetic field is from a source with a known location and of a known strength then, by using a table of offsets based upon the relative range to the known source of the magnetic field (i.e. based upon the determined position of the device and the known position and strength of the source of the magnetic field) or comparing the determined position of the device to a geolocated model of the region of magnetic interference, a dynamic offset may be determined and applied such that the heading is adjusted accordingly and hence sensor mode may still remain an option.

9. Known proximity to or location in known areas of strong magnetic fields based upon location of the device. If the device is close to areas or objects that have high magnetic fields, such as power cables, speakers such as those used in concert halls or a building with a high steel content for example, then sensor mode may be automatically disabled.

10. Poor Attitude Information

Analysis of the sensor suite indicating poor reliability from gyro or accelerometers due to high rate of motion such as in a banking aircraft or a rapidly cornering vehicle. In this case sensor mode may be automatically disabled.

11. Uncalibrated Sensors

User failure or device inability to calibrate the sensor suite. In this case sensor mode may be automatically disabled and the user alerted.

There would also be instances where both visual mode and sensor mode could be used in combination, especially when aligning graphics to real world scenes. Determining how the device is used in this manner could be set by the user as their default means or some pre-set software algorithm for example failing to find sufficient objects of interest in view using one method would automatically seek to use both methods essentially simultaneously.

The results of both types of search could be displayed to the user for manual selection. This could be further refined by using algorithms to determine the probability of accuracy of the results of each type of search based upon various sensed conditions such as location. For example a device in a known position in Tokyo is presented with the Eiffel Tower in Paris as a result of visual mode search and the Tokyo Tower as a result of the sensor mode search. Given the knowledge of the location of the device as determined by the GPS or other positioning means the device would display a very low (perhaps even 0%) probability that the result of the visual mode search is accurate.

The mode switching may be within one application that provides both types of search or may be from individual application to individual application, each providing a specific type of search.

### BRIEF DESCRIPTION OF THE DRAWING FIGURES

These and other features, aspects, and advantages of the present inventions will become better understood with regard to the following description, appended claims and drawings where:

FIGS. 1-3, are method block diagrams describing logic flow;

FIG. 4 is a geometric spatial diagram illustrating important spatial relationships between geometric constructs which specify system states;

FIG. 5 is an enhanced image showing aspects of these systems;

FIG. 6 also shows an enhanced image based upon a search having geometric dependence; and

FIGS. 7-9 additionally illustrate method block diagrams defining program logic.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Mobile Device

By ‘mobile device’ it is meant a mobile computing platform having physical state measuring capacity including position, location and orientation whose position and orientation may vary or be varied by a user—in example a hand held computing device such as a smart-phone.

### Sensor Mode Search

By “sensor mode search” it is meant a method of searching a database utilizing information regarding the physical state of the device. This physical state may include, but is not limited to, the location or position of the device and the attitude or pointing direction of the device.

### Visual Mode Search

By “visual mode search” it is meant a method of searching a database utilizing information ascertained by analysis of a captured image.

### PREFERRED EMBODIMENTS OF THE INVENTION

In accordance with each preferred embodiment of the inventions, search mode switching methods are provided. It will be appreciated that each of the embodiments described include methods and that methods of one preferred embodiment may be different than methods of another embodiment. Accordingly, limitations read in one example should not be carried forward and implicitly assumed to be part of an alternate example.

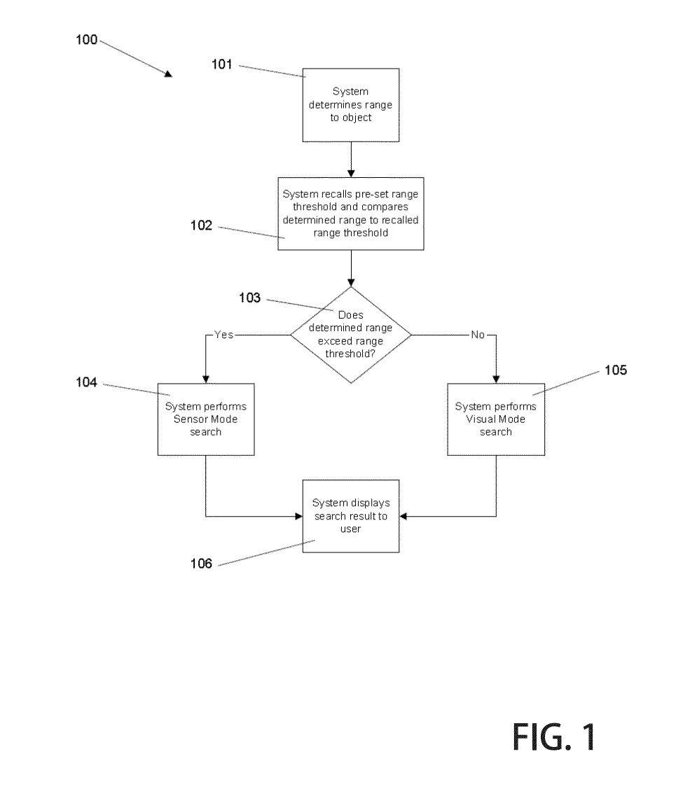

FIG. 1 is a flowchart 100 that illustrates the general version of the search mode switching methods. In step 101 the system determines the range to the object of interest. This ranging may be done by determining the focal plane distance of the imaging means or alternatively may be accomplished by active ranging such as a laser, acoustic range finder, radar or other apparatus. In step 102 the system recalls a pre-set range threshold, or range gate, and compares this threshold to the determined range to the object of interest. In step 103 the system determines if the determined range to the object of interest exceeds the range threshold. If the determined range to the object of interest does exceed the range threshold then the flowchart branches to step 104. If the determined range to the object of interest does not exceed the range threshold then the flowchart branches to step 105. In step 104 the system performs a sensor mode search and then displays the results of this search to the user (step 106). In step 104 the system performs a visual mode search and then displays the results of this search to the user in step 106.

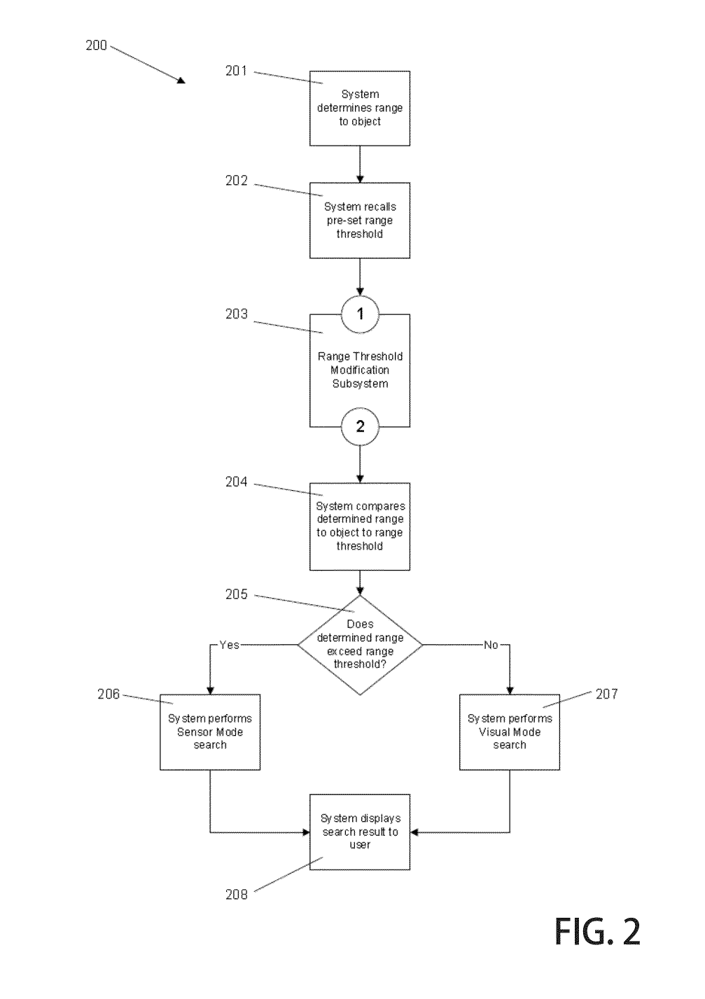

FIG. 2 is a flowchart 200 that illustrates a more advanced version of the search mode switching methods incorporating modification of the range threshold based upon various conditions. In step 201 the system determines the range to the object of interest. This ranging may be done by determining the focal plane distance of the imaging means or alternatively may be accomplished by active ranging such as a laser or acoustic range finder, radar or other apparatus. In step 202 the system recalls a pre-set range threshold, or range gate. In step 203 the system potentially modifies the range threshold using the Range Threshold Modification Sub-System.

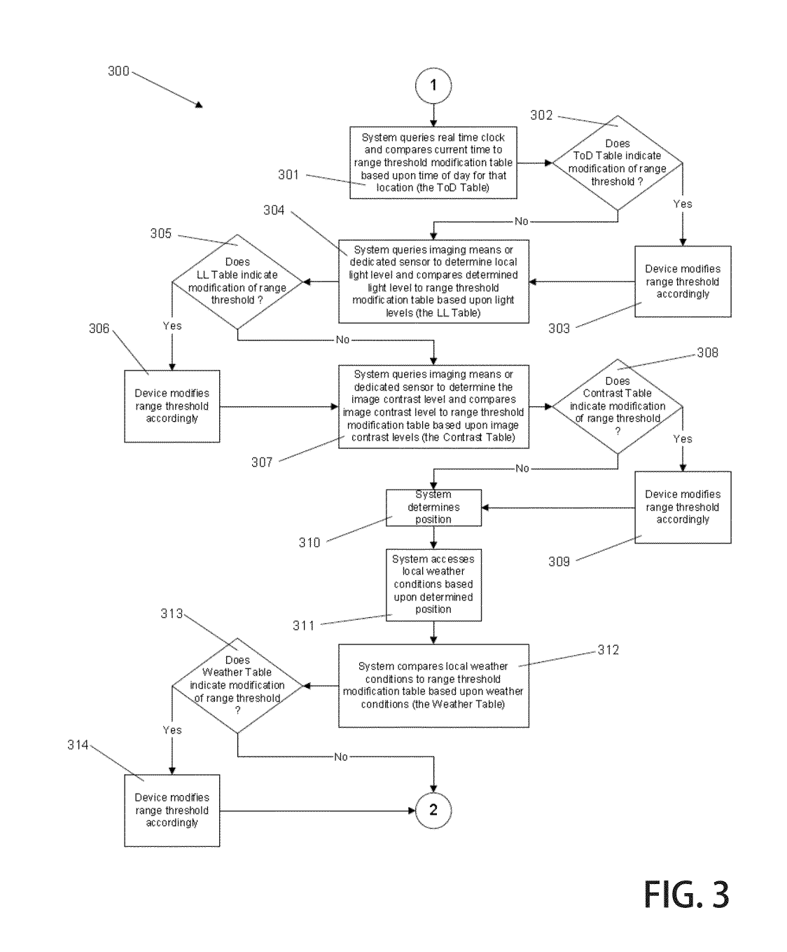

FIG. 3 is a flowchart 300 that illustrates the operation of the Range Threshold Modification Sub-System. In step 301 the system queries its real time clock (most typically from GPS), approximate position and a table of time offsets for each season and compares the current local time to a range threshold modification table based upon the time of day (the “ToD Table”). For example, if the clock indicates that it is currently night then the table would indicate that the threshold should be reduced by 50% (or other defined percentage) because visual mode Search will be ineffective in such conditions. In step 302 the system determines if the ToD Table indicates a modification of the range threshold is required. If a modification of the range threshold is required the flowchart branches to step 303 at which the range threshold is modified as required and then branches to step 304. If a modification of the range threshold is not required the flowchart branches directly to step 304. In step 304 the system queries its imaging means or a separate detector, typically a photodetector, dedicated to detection of light levels to determine the local light level and compares the local light level to a range threshold modification table based upon light levels (the “LL Table”). For example, if the light level is low then the table would indicate that the threshold should be reduced by 50% (or other defined percentage) because visual mode Search will be ineffective in such conditions. In step 305 the system determines if the LL Table indicates a modification of the range threshold is required. If a modification of the range threshold is required the flowchart branches to step 306 at which the range threshold is modified as required and then branches to step 307. If a modification of the range threshold is not required the flowchart branches directly to step 307. In step 307 the system queries its imaging means to determine the image contrast level and compares the determined image contrast level to a range threshold modification table based upon image contrast levels (the “Contrast Table”). For example, if the image contrast is high then the table would indicate that the threshold should be reduced by 50% (or other defined percentage) because detail will be hard to ascertain from the imager and hence visual mode Search will be ineffective in such conditions. In step 308 the system determines if the Contrast Table indicates a modification of the range threshold is required. If a modification of the range threshold is required the flowchart branches to step 309 at which the range threshold is modified as required and then branches to step 310. If a modification of the range threshold is not required the flowchart branches directly to step 310. In step 310 the system determines its position or location. This may be done by querying a GPS (Global Positioning System) or other positioning means associated with the system. In step 311 the system accesses the local weather conditions based upon the determined position. The local weather conditions may be accessed, for example, via WiFi or some other wireless connection such as direct access to NOAA radio or internet via cellular systems. In step 312 the system compares the local weather conditions to a range threshold modification table based upon image contrast levels (the “Weather Table”). For example, if the local weather is for fog then the table would indicate that the threshold should be reduced by 50% (or other defined percentage) because detail will be hard to ascertain from the imager and hence visual mode Search will be ineffective in such conditions. In step 313 the system determines if the Weather Table indicates a modification of the range threshold is required. If a modification of the range threshold is required the flowchart branches to step 314 at which the range threshold is modified as required and then branches to step 204. If a modification of the range threshold is not required the flowchart branches directly to step 204. It should be noted that the use of the ToD Table, LL Table and Contrast Table only require the system access to the imaging means. The use of the Weather Table requires use of the GPS or other positioning means and access to local weather conditions and hence will increase the power consumption of the device and potentially slow down the response time of the system. Each type of modification of the range threshold is provided as an example and it may be appreciated that each may be utilized individually or in various combinations as desired. In step 204 the system compares the range threshold to the determined range to the object of interest. Note that depending upon conditions the range threshold may not be modified at all. In step 205 the system determines if the determined range to the object of interest exceeds the range threshold. If the determined range to the object of interest does exceed the range threshold then the flowchart branches to step 206. If the determined range to the object of interest does not exceed the range threshold then the flowchart branches to step 207. In step 206 the system performs a sensor mode search and then displays the results of this search to the user (step 208). In step 207 the system performs a visual mode search and then displays the results of this search to the user in step 208.

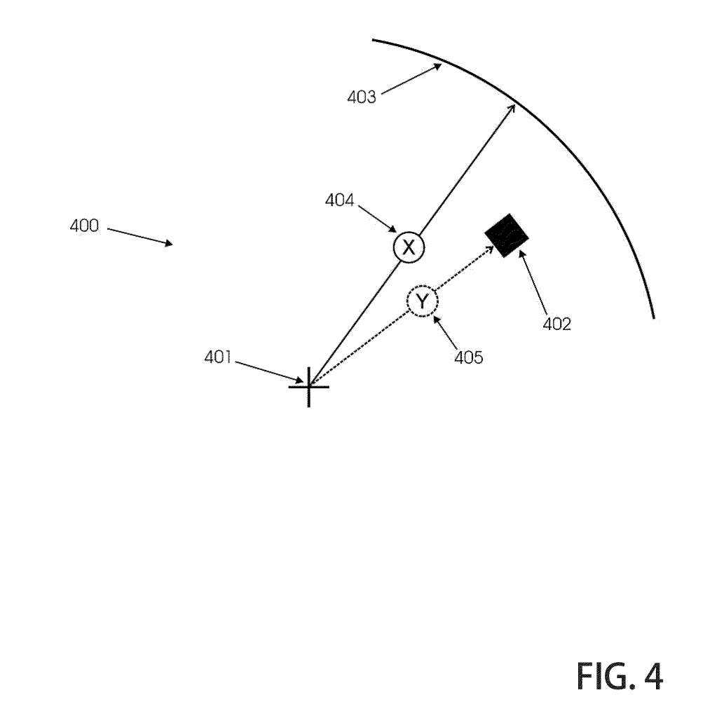

FIG. 4 is a line diagram 400 illustrating the concept of a range threshold or range gate. A device is located at position 401. A range gate 403 of distance X 404 is shown in relation to position 401. An object 402 is at a distance Y 405 from position 401. In this example distance Y 405 is less than distance X 404 and therefore the range to object 402 from position 401 is below the range threshold.

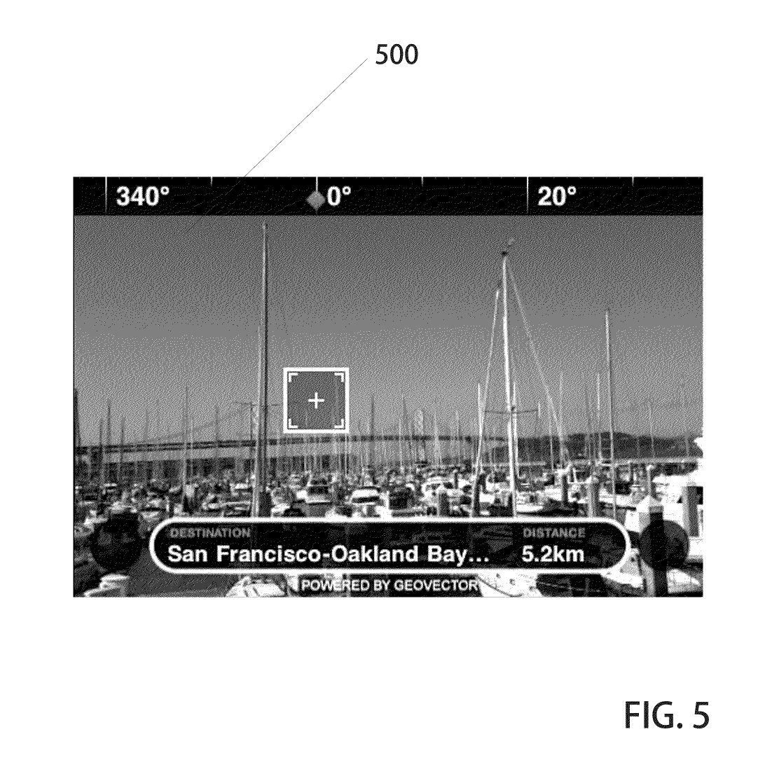

FIG. 5 is an image 500 illustrating the augmented reality result of a sensor mode search as it may be displayed to a user. In this case the “World Surfer” iPhone application by GeoVector Corporation has been used to recall and display information relating to an object, the San Francisco Oakland Bay Bridge, which is both far away and whose outline is obscured or partly obstructed by the sailboat masts in the South Beach Marina.

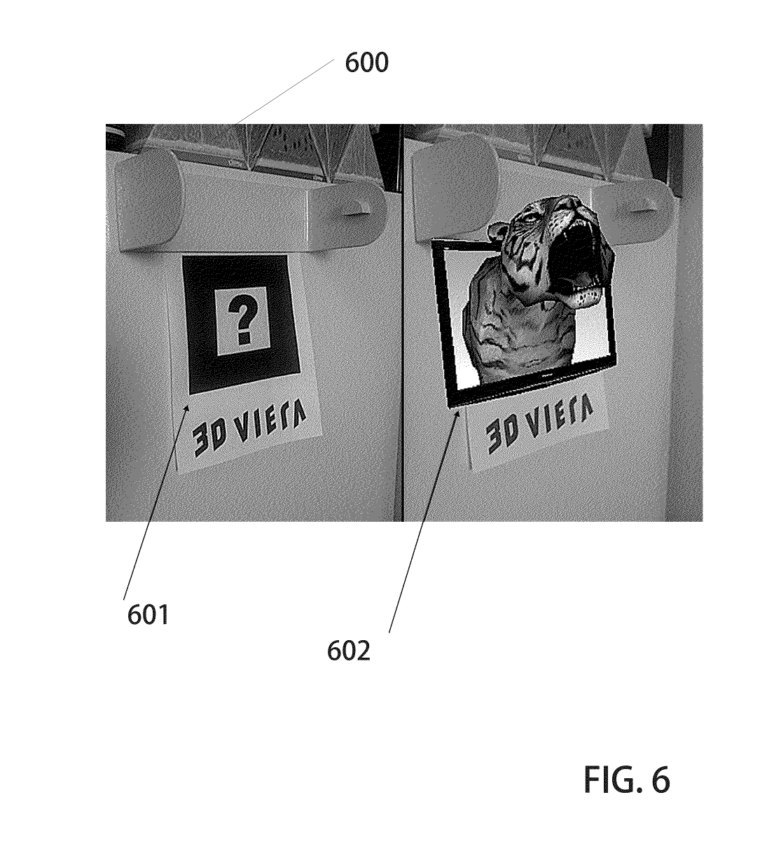

FIG. 6 is a double image 600 illustrating the augmented reality result of a visual mode search as it may be displayed to a user. In this case the object is determined to be very close to the device and the “Panasonic 3D Viera AR Greeting” application for iPhone from Panasonic Corporation is utilized. The application “recognizes” the marker 601 by analyzing the image and generates a 3D graphic 602 that is viewed in the correct perspective in relation to the marker 601.

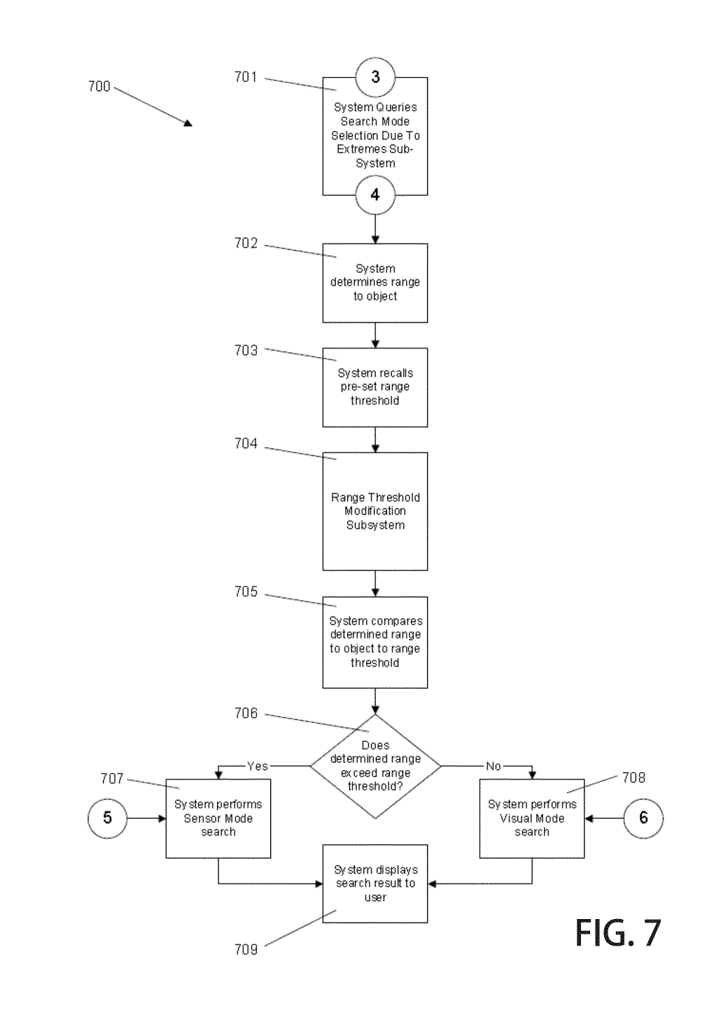

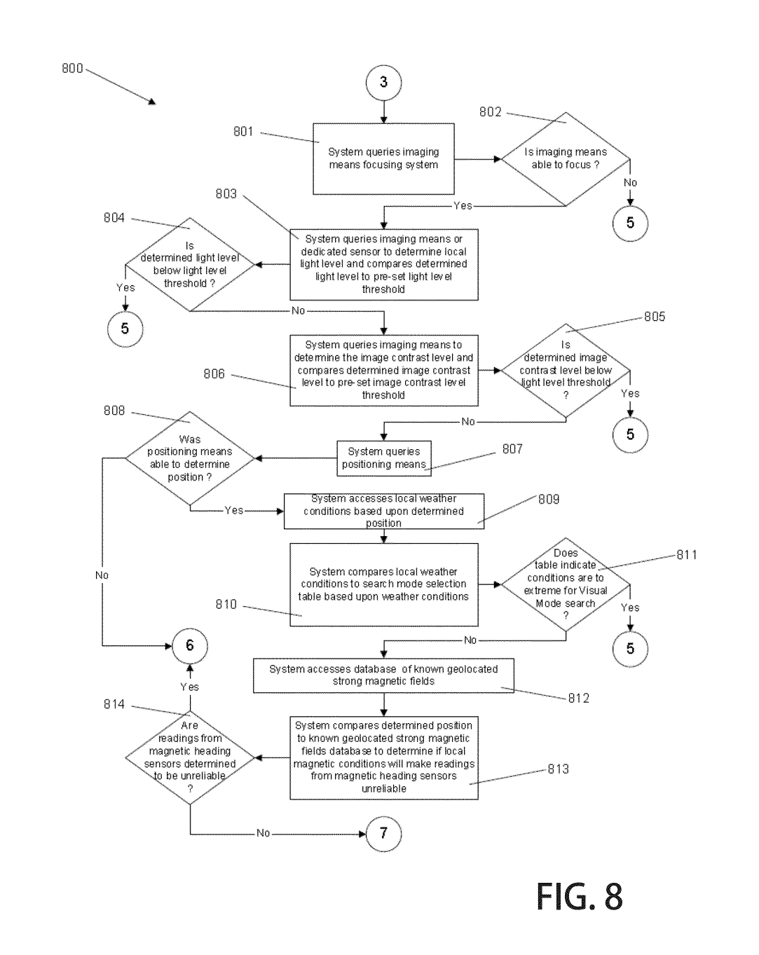

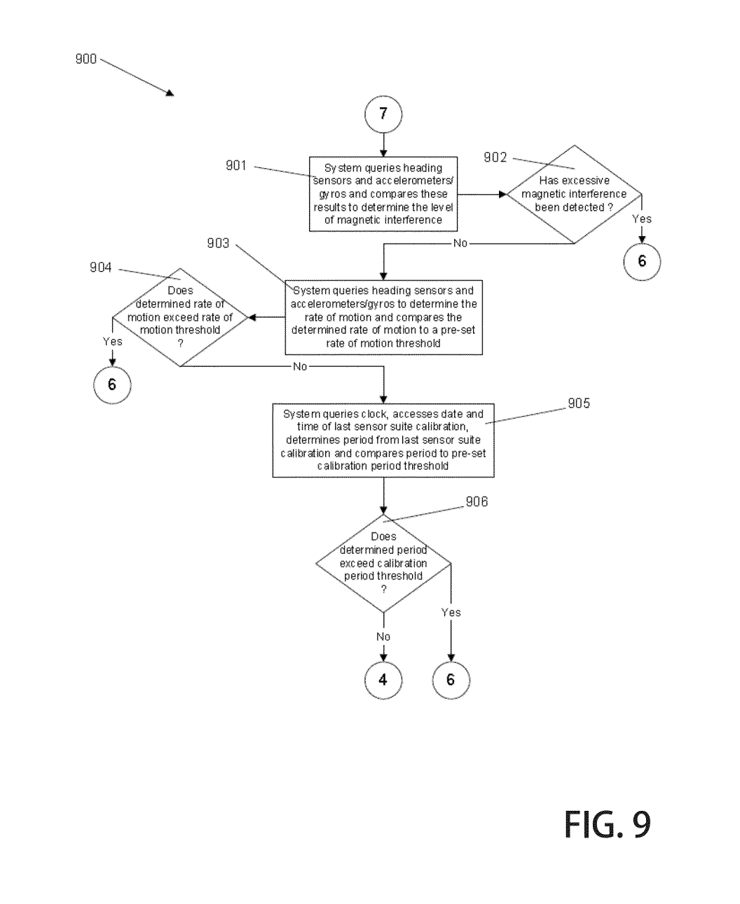

FIG. 7 is a flowchart 700 that illustrates a more advanced version of the search mode switching methods further incorporating a Search Mode Selection Due to Extremes Sub-System 701. FIGS. 8 and 9 are flowcharts 800 and 900 that illustrate the operation of the Search Mode Selection Due to Extremes Sub-System 701. In step 801 the device queries the imaging means (camera) focusing system. In step 802 the device determines if the imaging means is able to focus. If the imaging means is able to focus the flowchart branches to step 803. If the imaging means is not able to focus the flowchart branches to step 707. In step 803 the device queries the imaging means or a dedicated photo detector to determine the local light level and compares this determined local light level to a pre-set light level threshold. In step 804 the device determines if the local light level is below the light level threshold. If the local light level is below the light level threshold then the flowchart branches to step 707. If the local light level is not below the light level threshold then the flowchart branches to step 806. In step 806 the device queries the imaging means to determine the image contrast level and compares this determined image contrast level to a pre-set image contrast threshold. In step 805 the device determines if the image contrast level is below the image contrast level threshold. If the image contrast level is below the image contrast level threshold then the flowchart branches to step 707. If the local light level is not below the image contrast level threshold then the flowchart branches to step 807. In step 807 the device queries the positioning means. The positioning means may be a GPS (Global Positioning System) or other positioning means associated with the system. In step 808 the device determines whether the positioning means was able to determine the position of the device. If the positioning means was not able to determine the position of the device the flowchart branches to step 708. If the positioning means was able to determine the position of the device the flowchart branches to step 809. In step 809 the system accesses the local weather conditions based upon the determined position. The local weather conditions may be accessed for example by WiFi or some other wireless connection such as direct access to NOAA radio or internet via cellular systems. In step 810 the system compares the local weather conditions to the search mode selection table based on weather conditions. In Step 811 the system determines if the search mode selection table indicates that the local weather conditions are too extreme for a visual mode search to be effective. If the search mode selection table does indicate that the local weather conditions are too extreme for a visual mode search to be effective then the flowchart branches to step 707. If the search mode selection table does not indicate that the local weather conditions are too extreme for a visual mode search to be effective then the flowchart branches to step 812. In step 812 the system accesses a database of known geolocated strong magnetic fields. These magnetic fields may, for example, be power cables, buildings with a high steel content or speakers such as those used for concerts or be a local geological anomaly. In step 813 the system compares the determined position to the database of known geolocated strong magnetic fields to determine if the readings from magnetic heading sensors are locally unreliable. In step 814 the system determines if the readings from the magnetic heading sensors are locally unreliable. If the readings from the magnetic heading sensors are determined to be unreliable the flowchart branches to step 708. If the readings from the magnetic heading sensors are determined to not be unreliable the flowchart branches to step 901. In step 901 the system queries the magnetic heading sensors and the accelerometers and/or gyros and compares the results of these queries to determine if excessive magnetic interference is present. For example, complete saturation of the magnetic sensor or over a preset limit such as 90 degree swing reading with negligible motion detected by accelerometer and/or gyro. In this case sensor mode may be automatically disabled. In step 902 the system determines whether excessive magnetic interference is present. If excessive magnetic interference is present the flowchart branches to step 708. If excessive magnetic interference is not present the flowchart branches to step 903. In step 903 the system queries the accelerometers and/or gyros to determine the rate of motion and compares the determined rate of motion to a pre-set rate of motion threshold. In step 904 the system determines if the determined rate of motion exceeds the pre-set rate of motion threshold. For example, analysis of the sensor suite may indicate poor reliability from gyro or accelerometers due to high rate of motion such as in a banking aircraft or a rapidly cornering vehicle. If the rate of motion does exceed the pre-set rate of motion threshold the flowchart branches to step 708. If the rate of motion does not exceed the pre-set rate of motion threshold the flowchart branches to step 905. In step 905 the system queries the real time clock (most typically from GPS), accesses the date and time of the last sensor suite calibration (either by the user of the device or by the device itself), determines the period of time elapsed from the last sensor suite calibration and compares this determined calibration period to a pre-set calibration period threshold. In step 906 the system determines if the determined calibration period exceeds the pre-determined calibration period threshold. If the determined calibration period does exceed the pre-determined calibration period threshold then the flowchart branches to step 708. If the determined calibration period does not exceed the pre-determined calibration period threshold then the flowchart branches to step 702. Each type of method to determine which search mode to use is provided as an example and it may be appreciated that each may be utilized individually or in various combinations as desired. In step 702 the system determines the range to the object of interest. This ranging may be done by determining the focal plane distance of the imaging means or alternatively may be accomplished by active ranging such as a laser or acoustic range finder, radar or other apparatus. In step 703 the system recalls a pre-set range threshold, or range gate. In step 704 the system potentially modifies the range threshold using the Range Threshold Modification Sub-System. The Range Modification Threshold Modification Subsystem is well described in the text describing FIG. 2 above and its operation is illustrated in FIG. 3. In step 705 the system compares the range threshold to the determined range to the object of interest. Note that depending upon conditions the range threshold may not be modified at all. In step 706 the system determines if the determined range to the object of interest exceeds the range threshold. If the determined range to the object of interest does exceed the range threshold then the flowchart branches to step 706. If the determined range to the object of interest does not exceed the range threshold then the flowchart branches to step 708. In step 707 the system performs a sensor mode search and then displays the results of this search to the user in step 709. In step 207 the system performs a visual mode search and then displays the results of this search to the user in step 709.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how augmented reality visual systems may include search facility which is dependent upon multiple operational modes. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

1) Methods for selecting a search mode of an optical device comprising the steps,
a) making a system or environment measurement, and
b) selecting between alternative search modes based on said measurement.

2) Methods for selecting search modes of an optical device of claim 1, further comprising the steps,
a) determining distance to an object within a field-of-view of the optical device;
b) comparing determined distance to a prescribed threshold value; and
c) selecting between alternative search modes based on said comparison.

3) Methods of claim 2 where the “selecting between alternative search modes” step is further characterized as selecting a visual based search mode when the determined distance is less than the threshold value.

4) Methods of claim 2 where the “selecting between alternative search modes” step is characterized as selecting a sensor based search mode when the determined distance is greater than the threshold value.

5) Methods of claim 3, said visual based search mode is further characterized as one in which data is recalled from storage in a database based upon attributes derived from image processing.

6) Methods of claim 5, said visual based search mode is further characterized as one in which data is recalled from storage in a database based, said attributes derived from image processing comprise either from a group including: contrast, light level, color, color ratio, hue, and saturation.

7) Methods for selecting a search mode of claim 1, said “system or environment measurement” comprises determining a time of day value.

8) Methods for selecting a search mode of claim 1, said “system or environment measurement” comprises determining a numeric value characterization of instantaneous weather.

9) Methods for selecting modes of search of an optical device of claim 1, said prescribed threshold value is dynamically adjusted.

10) Methods of claim 9, adjustments to said prescribed threshold value are made based upon either of those from the group comprising: time of day, local light level, high contrast in image, and local weather conditions.
